(19) United States
(12) Patent Application Publication
(10) Pub. No.: US 2008/0255922 A1
(43) Pub. Date: Oct. 16, 2008

(54) PREFERRED COST BIDDING FOR ONLINE ADVERTISING

(76) Inventors: Jon Feldman, New York, NY (US); Guem R. Kim, New York, NY (US); Joanna Jung-Yen Liang, New York, NY (US); Balakrishnan Narendran, Berkeley Heights, NJ (US); Martin Pal, Metuchen, NJ (US); Rohit Rao, New York, NY (US); Adam Wildavsky, Jackson Heights, NY (US)

Correspondence Address: FISH & RICHARDSON P.C., PO BOX 1022, MINNEAPOLIS, MN, 55440-1022, US

(21) Appl. No.: 11/734,765

(22) Filed: Apr. 12, 2007

(51) Int. Cl. G06F 17/00

(52) U.S. Cl. 705/10

(57) ABSTRACT

In an online advertising system, preferred cost bidding allows advertisers to specify a preferred “average” cost target (e.g., cost-per-click (CPC), cost per thousand impressions (CPM)), rather than a “maximum” cost target (e.g., maximum CPC, CPM). The system attempts to bring the advertiser's overall advertising cost as close as possible to the advertiser's specified average cost, using an iterative process (e.g., a feedback loop) that updates bids for keywords using historical performance data for the key words. In some implementations, a bid is automatically adjusted in an adaptive way to compensate for natural changes in fluctuations of the market using historical performance data to compute a bid that is likely to result in an average cost (per click) that is close to the advertiser's preferred average target cost (per click).

### RELATED APPLICATIONS

The subject matter of this patent application is generally related to U.S. patent application Ser. No. 11/172,614, for “Determining And/Or Managing Offers Such As Bids For Advertising,” filed Jun. 30, 2005, Attorney Docket No. GP-372-00-US, which patent application is incorporated by reference herein in its entirety.

### TECHNICAL FIELD

The subject matter of this application is generally related to online advertising.

### BACKGROUND

Interactive media (e.g., the Internet) has great potential for improving the targeting of advertisements (“ads”) to receptive audiences. For example, some websites provide information search functionality that is based on keywords entered by the user seeking information. This user query can be an indicator of the type of information of interest to the user. By comparing the user query to a list of keywords specified by an advertiser, it is possible to provide targeted ads to the user. An example of such a system is AdWords™ offered by Google, Inc. (Mountain View, Calif.).

In some online advertising systems, advertisers pay for their ads on a cost-per-click (CPC) basis. In such systems, advertisers bid for ads by entering a maximum CPC bid. Those advertisers that prefer to work with averages may find it difficult to budget for advertising when they do not know how much each click will cost.

While the actual cost paid for each click is less than this maximum CPC bid, it can vary quite a bit, depending on factors like the specific keyword being bid on, the competitive landscape of other competing bidders, the time of day or day of week, etc. Those advertisers who prefer to work with the average cost they pay per click may find it difficult to budget for advertising when they do not know how much each click will actually cost. Similar cost management issues arise in other advertising systems where advertisers bid on, for example, a maximum cost per thousand impressions (CPM) basis, and are unable to predict how much they actually spend for these impressions.

To work around this missing functionality, some advertisers check and update keyword bids manually. If the average paid CPC is too low, an advertiser can raise one or more maximum CPC bids so as to ensure higher levels of success. If the advertiser is spending too much per click, one or more of the maximum CPCs are lowered. Accordingly, account managers who manage ad accounts for large advertisers can spend much of their time micro-managing ad campaigns to meet their client's CPC targets. Smaller advertisers often turn to third party bid managers to manage their accounts.

### SUMMARY

In an online advertising system, preferred cost bidding allows advertisers to specify a preferred “average” cost target (e.g., CPC, CPM), rather than a “maximum” cost target (e.g., maximum CPC, CPM). The system attempts to bring the advertiser's overall advertising cost as close as possible to the advertiser's specified average cost, using an iterative process (e.g., a feedback loop) that updates current bids for keywords using historical performance data for the key words.

In some implementations, a current bid is automatically adjusted in an adaptive way to compensate for natural changes in fluctuations of the market using historical performance data to compute a bid that is likely to result in an average cost (per click) that is close to the advertiser's preferred average target cost (per click).

In some implementations, a current bid for a keyword is automatically adjusted (e.g., multiple times a day) by setting the current bid equal to a linear combination of the current bid and a one or more previous bids (e.g., bids from a previous time period) determined by a linear projection of historical performance data for the keyword through a (0, 0) point on a plot of cost as a function of bid.

In some implementations, a method includes: identifying input specifying a target average cost for a keyword; and automatically updating a current bid for the keyword using historical performance data for the keyword to achieve the target average cost.

In some implementations, a method includes: receiving input specifying a target average cost for a key word; and automatically adjusting a current bid for the keyword during a time window to achieve the target average cost, using a linear combination of the current bid and a previous bid for a previous time window, determined by a linear projection through an origin point on a plot of cost as a function of bid.

In some implementations, a method includes: identifying input specifying a target average cost for a keyword; and automatically adjusting a current bid for the keyword by setting the current bid equal to a convex combination of weighted past linear projections on a plot of cost as a function of the target average bid.

With preferred cost bidding, advertisers can better control their costs and thereby maximize their returns by targeting a preferred average cost, rather than a maximum CPC or CPM.

### DESCRIPTION OF DRAWINGS

FIG. 1 is a block diagram of an implementation of an online advertising system.

FIG. 2 is an example of user interface that can be used by an advertiser to invoke a preferred cost bidding feature.

FIG. 3 is an example of a user interface that can be used by an advertiser to specify preferred average cost targets.

FIG. 4 is a flow diagram showing an example of a process for preferred cost bidding.

FIG. 5 is a block diagram showing an example of an automated bid management system for implementing preferred cost bidding.

FIG. 6 is block diagram showing an example of a system that can perform preferred cost bidding.

### DETAILED DESCRIPTION

### Advertising System Overview

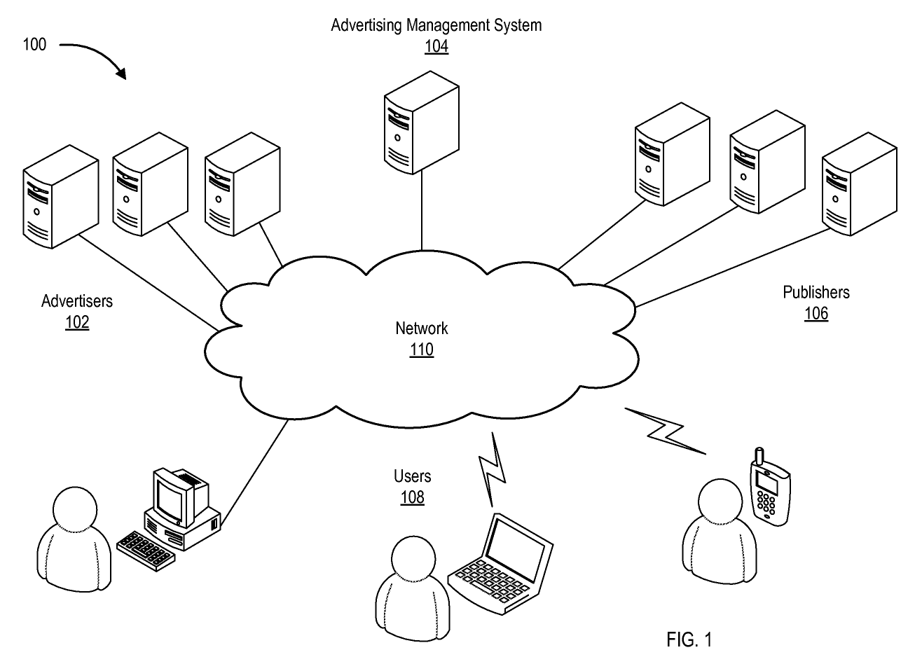

FIG. 1 is a block diagram of an implementation of an online advertising system 100. In some implementations, one or more advertisers 102 can directly, or indirectly, enter, maintain, and track advertisement (“ad”) information in an advertising management system 104. The ads may be in the form of graphical ads, such as banner ads, text only ads, image ads, audio ads, video ads, ads combining one of more of any of such components, etc., and be delivered over on or more different systems, e.g., Web delivery, mobile delivery, broadcast delivery or other delivery service. The ads may also include embedded information, such as a links, meta-information (e.g., RSS information), and/or machine executable instructions. One or more publishers 106 may submit requests for ads to the system 104. The system 104 responds by sending ads to the requesting publisher 106 for placement on one or more of the publisher's web properties (e.g.,. websites and other network-distributed content).

Other entities, such as users 108 and the advertisers 102, can provide usage information to the system 104, such as, for example, whether or not a conversion or click-through related to an ad has occurred. This usage information can include measured or observed user behavior related to ads that have been served. The system 104 performs financial transactions, such as crediting the publishers 106 and charging the advertisers 102 based on the usage information.

In this example, a computing network is shown that includes a network based delivery paradigm. This is only an example, other delivery or architecture paradigms are possible.

A computer network 110, such as a local area network (LAN), wide area network (WAN), the Internet, or a combination thereof, connects the advertisers 102, the system 104, the publishers 106, and the users 108.

One example of a publisher 106 is a general content server that receives requests for content (e.g., articles, discussion threads, music, video, graphics, search results, web page listings, information feeds, etc.), and retrieves the requested content in response to the request. The content server may submit a request for ads to an ad server in the system 104. The ad request may include a number of ads desired. The ad request may also include content request information. This information can include the content itself (e.g., page or other content document), a category corresponding to the content or the content request (e.g., arts, business, computers, arts-movies, arts-music, etc.), part or all of the content request, content age, content type (e.g., text, graphics, video, audio, mixed media, etc.), geo-location information, etc.

In some implementations, the content server can combine the requested content with one or more of the ads provided by the system 104. This combined content and ads can be sent to the user 108 that requested the content for presentation in a viewer (e.g., a browser or other content display system). The content server can transmit information about the ads back to the ad server, including information describing how, when, and/or where the ads are to be delivered or rendered (e.g., in HTML or JavaScript™).

As can be appreciated from the foregoing, the advertising management system 104 can serve publishers 106, such as content servers and search services. The system 104 permits serving of ads targeted to content (e.g., documents) served by content servers. For example, a network or inter-network may include an ad server serving targeted ads in response to requests from a search service with ad spots for sale. Suppose that the inter-network is the World Wide Web. The search service can be capable of crawling much or all of the content. Some of this content can include ad spots (also referred to as “inventory”) available. In one specific example, one or more content servers may include one or more documents. Documents may include web pages, email, content, embedded information (e.g., embedded media), meta-information and machine executable instructions, and ad spots available. The ads inserted into ad spots in a document can vary each time the document is served or, alternatively, can have a static association with a given document.

### Preferred Cost Bidding

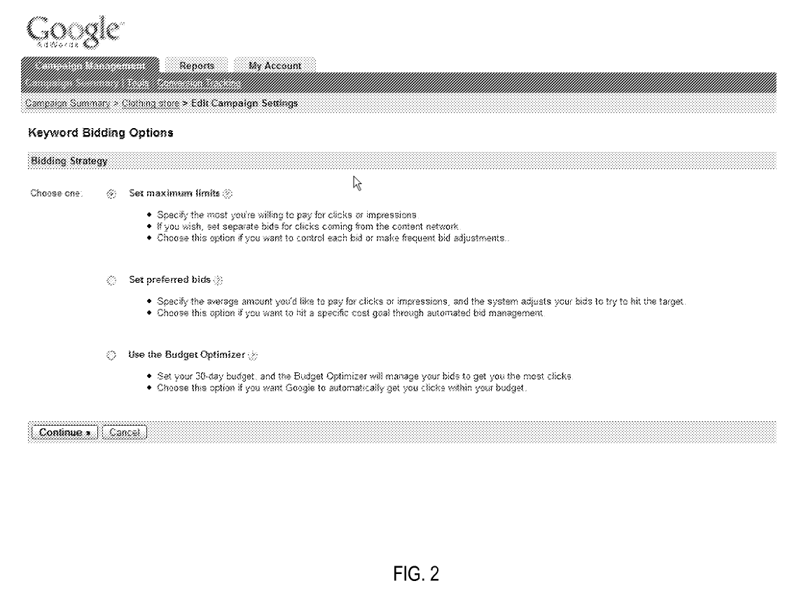

FIG. 2 is an example of user interface that can be used by an advertiser to invoke a preferred cost bidding feature. In the example shown, the user selects a “Set preferred bids” in a bidding strategy section of a campaign management tab. The user interface can be generated by the system 104, for example. In some implementations, the system 104 allows preferred cost bidding, where advertisers 102 specify an “average” CPC or cost per thousand impressions (CPM), rather than a “maximum” CPC or CPM. The system 104 then attempts to bring the advertiser's overall cost in a defined time period as close as possible to the specified average cost, using an iterative process that updates current bids on keywords using historical performance data for the key words.

The disclosed implementations are not limited to targeting an average CPC or CPM for keywords. For example, in some implementations an advertiser can bid for the right to display an ad on a specific site. Also, advertisers can specify average target metrics other than CPC or CPM, such as specifying a target average return on investment (ROI), average cost per conversion/action (CPA) or any other desired metric.

In some implementations, to compute bids the historical performance data about the performance of each keyword is needed. This data can include but is not limited to: impressions, clicks, cost, bids, user-specified preferred CPC, etc. The historical performance data can be collected and stored in various places, such as a database (e.g., MySQL database), table or any other suitable data structure. For example, the historical performance data can be retrieved from logs generated by bidding processes. These log files can contain current statistical data starting when a bid is first made on a campaign. The logs can be processed on a scheduled basis (e.g., every hour) and/or in response to one or more trigger events, to extract the data and write it to a file having a structured format, for example. The file can then be accessed by the preferred cost bidding system and processes, as needed. In some implementations, data is stored for only those keywords which received at least one click.

### Setting Initial Bids

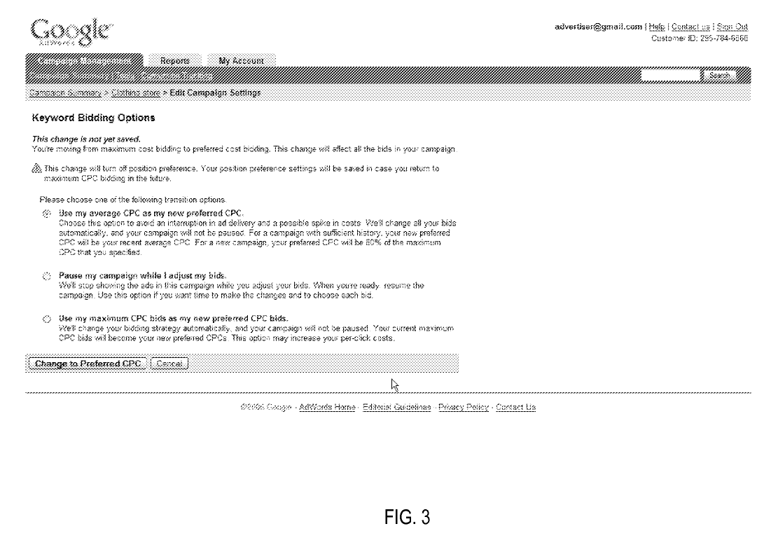

FIG. 3 is an example of a user interface that can be used by an advertiser to specify preferred average cost targets. In some implementations, when an advertiser invokes the preferred cost bidding feature for the first time (e.g., through the user interface shown in FIG. 2), the advertiser specifies their preferred average cost targets. FIG. 3 shows some options for specifying preferred average cost targets. These options are described as follows:
Use the historical average CPC or other metric (e.g., CPM, CPA, ROI) as a preferred average cost target.
Use the current maximum CPC or other metric (e.g., CPM, CPA, ROI) as the preferred average cost target.
Pause the campaign to allow the advertiser to enter a preferred average cost target manually.

Given the advertiser's specified preferred average cost target, an initial bid can be set. For example, if the advertiser specifies the historical average as the preferred average cost target, then the most recent maximum CPC or other metric can be used as the advertiser's initial bid. If the advertiser specifies a target that is not equal to the historical average, then the bid can be a multiple of the advertiser's preferred average cost target (e.g., 1.25 times the target value). Other schemes for specifying a preferred average cost target can be used, including combining the approaches described above.

### Updating Bids Over Time

After an initial bid is set, the bid is periodically updated to achieve the advertiser's target CPC (or other metric) for a next time period (e.g., once a day). In other implementations, an average bid can be managed over multiple time periods. In some implementations, the bid can be updated multiple times over a single accounting period (e.g., a day). This strategy helps even out fluctuations (e.g., underbidding early in the day can be corrected by overbidding later in the day). It also helps mitigate problems in markets where there is no bid that exactly achieves the target. For example, if a given bid B results in an average cost below the desired target but the bid B plus one cent results in an average cost well above the target, there is no single bid that would achieve the target exactly. However, by bidding B part of the day and B plus one cent for part of the day, the target can be hit more precisely.

In some implementations, a bid can be computed using only the initial bid and CPC for the previous x (e.g., two) time periods, where a time period can be any suitable period of time (e.g., an hour, a day, a week, etc.). Using fewer time periods allows greater adaptability to changing keyword markets. In some implementations, we define the following parameters:
T=target CPC bid.
Tmax=maximum allowable bid (e.g., Tmax=2T or a user-defined parameter).
B_{c}, K_{c}, C_{c}: current bid, number of clicks, total cost for current time period.
Bₚ, Kₚ, Cₚ: previous bid, number of clicks, total cost for previous time period.
B=a bid output of an automated bid manager (e.g., T<=B<=Tₘₐₓ).

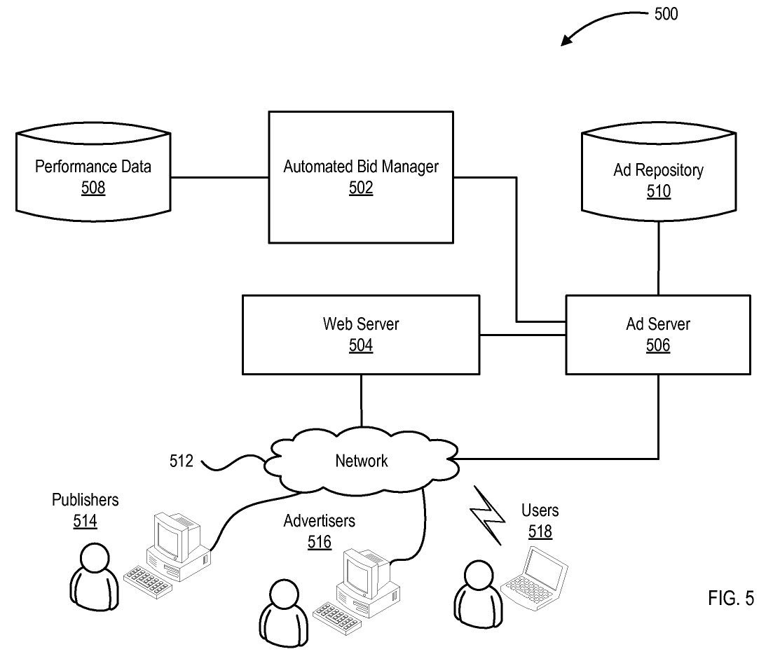

Additionally, there are several cases to consider in updating a bid based on the number of clicks, K_{c}, Kₚ, for the current and previous time periods, respectively:
(i) If K_{c}=0, the ad did not receive any clicks for the current time period), then the automated bid manager (e.g., the automated bid manager 502 in FIG. 5) does not change the current bid. Receiving no clicks can result from no impressions, or because the ad was never clicked despite the impressions. In the first case, since the bid is greater than the target bid, if it was possible to get an impression where CPC is T, then the bid would have been high enough to get it. In this case, one could infer there is no reason to change the current bid, e.g., the target bid itself is unreasonable. In the second case, the lack of clicks is not a function of the bid, but rather the ad, the users, etc.
(ii) If K_{c}>0, but Kₚ=0 (or we have only one data point), B_{c}, K_{c} and C_{c} can be used to calculate bids. To do this, in one implementation a line on a plot of CPC as a function of bid can be used, where the line passes through the origin and the point (B_{c}, C_{c}/K_{c}). A bid can be calculated on that line that would achieve the target T. More specifically, the bid can be set equal to (T B_{c} K_{c}/C_{c}). In this case, a bid can be more than Tₘₐₓ, in which case the bid can be set to Tₘₐₓ.
(iii) Otherwise, the bid can be adjusted based on both data points. Example strategies for handling this third case are described below.

### Simple Linear Projection

Regarding (B_{c}, C_{c}/K_{c}) and (Bₚ, Cₚ/Kₚ) as two data points on a plot of CPC as a function of bid, one strategy is to calculate the line intersecting those two points, and set the bid to the point on that line that achieves the desired target. It could be the case, however, that the calculated bid is either less than T, or more than Tₘₐₓ, in which case the bid can be reset to T or Tₘₐₓ, accordingly. It is expected that the line calculated has a non-negative slope, i.e., that CPC is a non-decreasing function of the bid. However, fluctuations in the market and differences in particular queries on which the keyword is matched may result in a negative slope. A negative slope can be handled as described above for case (ii).

### Linear Projection To (0,0)

A drawback to the simple linear projection strategy is that it assumes low noise in the data. It may be that using these two points to project could lead to erratic behavior. To stabilize the calculation, in one implementation the point (0,0), i.e., an origin point, can be included in the linear projection calculation. For example, both points can be projected with origin (0,0) and the average of the two resulting bids can be taken. More specifically, we let B₁=T B_{c} K_{c}/C_{c}, and let B₂=T Bₚ Kₚ/Cₚ, then set the bid equal to the average of B₁ and B₂. In another implementation, we take the average of the two points, then project with (0,0) to calculate the bid. More specifically, we set B=(B_{c}+Bₚ)/2, and set P=(C_{c}/K_{c}+Cₚ/Kₚ)/2. Then the bid can be set equal to T B/P.

### Mixing In The Current Projection

Although perhaps more stable then simple linear projection, using a linear projection to (0,0) could also suffer from noise. To address the noise, in some implementations the bid can be set equal to a linear combination of the current bid and the bid calculated from the projection with (0,0). Note that with this strategy, we do not use case (ii) described above.

More specifically, we calculate B′=(T B_{c} K_{c}/C_{c}), and we set the bid equal to (1−p) B_{c}+p B′, where p is a number between 0 and 1. The variable, p, controls how much we weight the current data relative to the data from the past. Note that if K_{c}=0 (i.e., there are no clicks), then we still use case (i) above, and so effectively B′=B_{c}.

In general, the current bid will be a convex combination of the projections from the past, where the weight on a projection decreases geometrically as you go into the past. More specifically, if Bᵢ is the ith bid we make, and Cᵢ and Kᵢ are the cost and clicks that result from that bid, then let Jᵢ=(T Bᵢ Kᵢ/Cᵢ) be the bid calculated from the projection. For the first bid, we have no history, so we can have J₁=(3/2)T, which can be an arbitrary value. This value can be set using the initial bid options described above. Also, if at any point we have Kᵢ=0 (i.e., we have no clicks) then Jᵢ=Bᵢ₋₁ and, Bᵢ will have the property:

Bᵢ=p Jᵢ₋₁+p(1−p)Jᵢ₋₂+p(1−p)²Jᵢ₋₃+ . . . +p(1−p)ⁱ⁻³J₂+(1−p)ⁱ⁻² J₁,

where p can be around ⅓ or any other suitable value.

Using this third strategy, updates to the bid can be made once every 24 hours, for example.

### Managing Average Bids Over Multiple Time Periods

In some implementations, a multi-period technique maintains two bids, B_lo and B_hi, such that B_lo<B_hi. In the past, bidding B_lo yielded an average cost of Cpc_lo<Cpc_target, and bidding B_hi yielded an average cost of Cpc_hi>=Cpc_target. If B_hi−B_lo> minimum billable unit (mbu) (e.g., 1 cent), the process is in a search phase. In the search phase, the process tries to reduce the interval of uncertainty by setting the bid B somewhere between B_lo and B_hi. If B_hi−B_lo=mbu, the process enters a stable phase when it bids either B_lo or B_hi, depending on whether the average over the past x hours (e.g., 24 hours) was above or below the target. In an ideal static market, the process would stay in the stable phase forever. However, since the market conditions do change, the process has a way to invalidate the bracket bids and restart the search.

Depending on the available data, the process can do one of the following:
If no previous bidding data available, then bid the default x*Cpc_target, where x is an arbitrary constant used to set initial bids as a function of the target.
If not enough traffic (e.g., clicks) in the most recent bidding period, do not change the bid; wait for more traffic to accumulate with the same bid.
If only one valid data point is available, then use the linear projection of the data point with (0,0) to compute the bid B.
If two valid bids, B_lo and B_hi, with their corresponding average CPC values Cpc_lo<Cpc_target and Cpc_hi>=Cpc_target are available, then enter search phase or stable phase. Search Phase: If B_hi−B_lo>mbu, pick a bid B, such that B_lo<B<B_hi. For example, pick a middle point B=(B_lo+B_hi)/2, linear interpolate B=[(Cpc_hi−Cpc_target)*B_lo+(Cpc_target−Cpc_low)*B_hi]/(Cpc_hi−Cpc_lo), or some combination of the above. Stable Phase: if B_hi−B_lo=mbu, bid B=B_lo if the average in the past x hours (e.g., 24 hours) was below Cpc_target and B_hi otherwise.

### Data Points

In the processes described above, each data point corresponds to a “bidding period,” and includes data such as the time of the beginning and end of the bidding period, the bid that was active during the bidding period, as well as the number of clicks, impressions and cost accrued over the bidding period. The average cost (e.g., CPC) over a bidding period is equal to the cost divided by the number of clicks.

In general, each bidding period corresponds to a time interval between two bid updates. However, some intervals may not contain enough data to reliably compute CPC (in particular, if the number of clicks in a bidding period is zero, the CPC is undefined). In this case, we can aggregate multiple consecutive update intervals into a single bidding period. We only aggregate intervals over which the bid remained unchanged.

### Determining Bracketed Bids

In some implementations, we let p_lo be the most recent bidding period in which the average CPC was below Cpc_target. Let B_lo be our bid in that period, and Cpc_lo be the average CPC in that period. The bid B_lo is deemed valid, if there is no later period p′ in which we bid B′<=B_lo and Cpc′, the average Cpc cost per click in that period is greater than Cpc_target.

Similarly, we can define B_hi and Cpc_hi. Let p_hi be the most recent bidding period in which the average CPC was greater or equal to Cpc_target. Let B_hi be our bid in that period, and Cpc_hi be the average Cpc in that period. The bid B_hi is deemed valid, if there is no later period p′ in which we bid B′>=B_hi and Cpc′, the average Cpc cost per click in that period is less than Cpc_target.

Note that either B_lo or B_hi can be invalid, but as long as we have at least one data point, one of them can be defined and valid. In case that only one of these two points is valid, we can use it as the sole data point.

### Other Metrics

The processes described above for preferred cost bidding can be used to manage the average cost in metrics other than CPC. For example, instead of targeting a certain CPC, we can target CPM, cost per action (CPA), average conversion value, etc.

### Fitness Formula

In some implementations, the various processes described above can be selected based on fitness formula that minimizes the click-weighted average distance to target, which can be calculated for each keyword as follows:

$$Ave . Dist . To Tgt . = \frac{{\sum }_{i = 1}^{N days} \vert 1 - \frac{Actual ( i )}{Tgt .} \vert * Clicks ( i )}{Total Clicks} ,$$

where Tgt. is the target cost (e.g., the advertiser's preferred CPC for a keyword), Actual (i) is the average cost on day i, and Clicks(i) is the number of clicks on day i. This formula can be generalized to a group of keywords.

### Example Preferred Cost Bidding Process

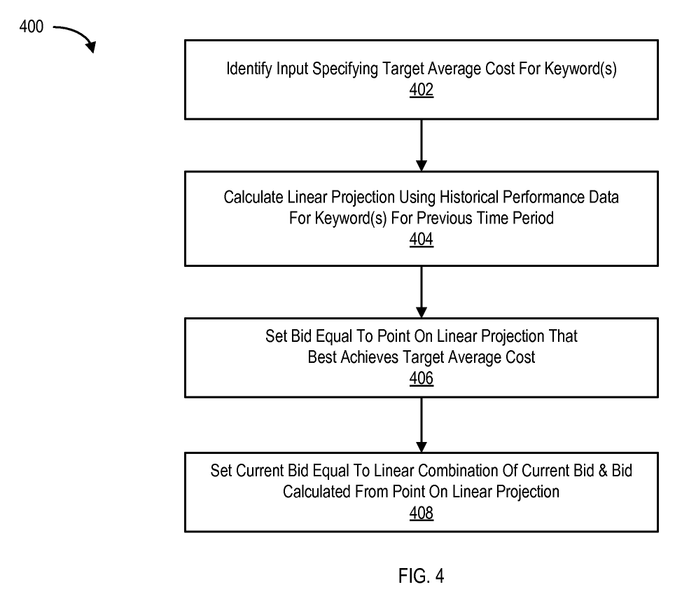

FIG. 4 is a flow diagram showing an example process 400 for preferred cost bidding. The process 400 begins by identifying input specifying a target average cost for a one or more keywords (402). A linear projection is calculated using historical performance data for the keywords for one or more previous time periods (404). In some implementations, the linear projection can be conceptually represented as a line on a plot of cost as a function of bid. In some implementations, the line includes the (0,0) point (i.e., the origin). A bid is generated by setting the bid equal to a point on the linear projection that best achieves the target average cost (406). The current bid is set equal to a linear combination of the current bid and the bid calculated from using the linear projection (408). In some implementations, the current bid is a convex combination of weighted past linear projections, where the weights on the linear projections decrease geometrically as you go into the past. Other weighting schemes are also possible.

### Automated Bid Management System

FIG. 5 is a block diagram showing an example of an automated bid management system 500 for implementing preferred cost bidding. In some implementations, the system 500 includes an automated bid manager 502, a Web server 504, an ad server 506, performance data repository 508 and ad repository 510. Publishers 514, advertisers 516 and users 518 communicate with the system 500 through network 512 (e.g., Internet, intranet, wireless network, television or radio broadcast network, etc.). Other configurations are possible.

In some implementations, advertisers 516 interact with the automated bid manager 502 through one or more user interfaces in Web pages provided by the Web server 504. FIGS. 2 and 3 are examples of such user interfaces. As described in reference to FIGS. 1-4, the advertiser 516 can specify a target average cost (e.g., average CPC) in a user interface, which is sent to the automated bid manager 502. The automated bid manager 502 runs a preferred cost bidding process (e.g., the process 400), which automatically adjusts a current bid using historical performance data stored in repository 508 to achieve the target average cost. An example of an automated bidding system is described in, for example, U.S. patent application Ser. No. 11/172,614, for “Determining And/Or Managing Offers Such As Bids For Advertising.”

In some implementations, the historical performance data can be provided by the ad server 506, which serves ads to, for example, a Web site or other Web property operated by a publisher 514. The ad server 506 can perform various ad targeting processes (e.g., based on keywords, ad context, user profiles, location, etc.) for selecting ads from the ad repository 510 for presentation to users 518. In some implementations, the ad server 506 combines ads with content (e.g., video, audio, digital photos), then serves the content and ads to users 518.

### Example Architecture

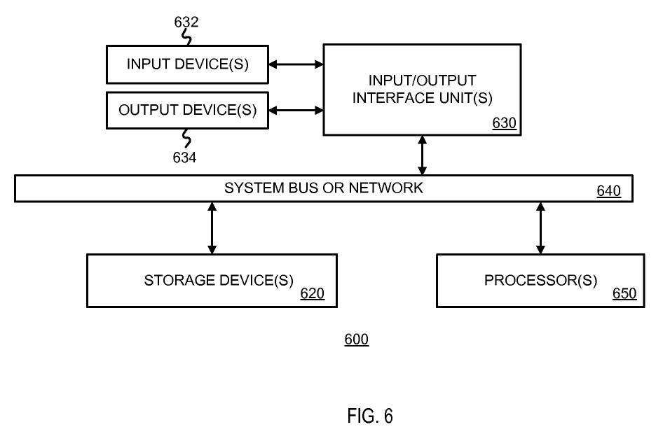

FIG. 6 is block diagram of a system 600 that can perform preferred cost bidding. The system 600 may include one or more processors 610, one or more input/output interface units 630, one or more storage devices 620, and one or more system buses and/or networks 640 for facilitating the communication of information among the coupled elements. One or more input devices 632 and one or more output devices 634 may be coupled with the one or more input/output interfaces 630.

The one or more processors 610 may execute machine-executable instructions (e.g., C or C++, Java, etc., running on the Solaris operating system available from Sun Microsystems Inc. of Palo Alto, Calif. or the Linux operating system widely available from a number of vendors such as Red Hat, Inc. of Durham, N.C.) to perform one or more aspects of the present invention. At least a portion of the machine executable instructions may be stored (temporarily or more permanently) on the one or more storage devices 620 and/or may be received from an external source via one or more input interface units 630.

In one embodiment, the system 600 may be one or more conventional personal computers. In this case, the processing units 610 may be one or more microprocessors. The bus 640 may include a system bus. The storage devices 620 may include system memory, such as read only memory (ROM) and/or random access memory (RAM). The storage devices 620 may also include a hard disk drive for reading from and writing to a hard disk, a magnetic disk drive for reading from or writing to a (e.g., removable) magnetic disk, and an optical disk drive for reading from or writing to a removable (magneto-) optical disk such as a compact disk or other (magneto-) optical media.

A user may enter commands and information into the personal computer through input devices 632, such as a keyboard and pointing device (e.g., a mouse) for example. Other input devices such as a microphone, a joystick, a game pad, a satellite dish, a scanner, or the like, may also (or alternatively) be included. These and other input devices are often connected to the processing unit(s) 610 through an appropriate interface 630 coupled to the system bus 640. The output devices 634 may include a monitor or other type of display device, which may also be connected to the system bus 640 via an appropriate interface. In addition to (or instead of) the monitor, the personal computer may include other output devices (not shown), such as speakers and printers for example.

The various operations described above may be performed by one or more systems 600, and the various information described above may be stored on one or more systems 600.

The disclosed embodiments can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of what is disclosed here, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of what being claims or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understand as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

A number of embodiments of the invention have been described. Nevertheless, it will be understood that various modifications may be made without departing from the spirit and scope of the invention.

What is claimed is:

1. A method comprising:
identifying input specifying a preferred average cost target for a keyword; and
automatically updating a bid for the keyword using historical performance data for the keyword to achieve the preferred average cost target.

2. The method of claim 1, wherein automatically updating a bid further comprises:
calculating a linear projection using historical performance data for a previous time period; and
setting the bid equal to a linear combination of the bid and a previous bid calculated from the linear projection.

3. The method of claim 2, wherein the linear projection includes an origin point.

4. The method of claim 1, wherein the preferred average cost target is from a group of average cost targets including: a historical average cost-per-click (CPC), average cost-per-action (CPA), average return on investment (ROI) and average cost per thousand impressions (CPM).

5. The method of claim 4, wherein the historical average CPC is set equal to a maximum CPC.

6. The method of claim 1, wherein the preferred average cost target is multiplied by a factor.

7. The method of claim 1, wherein the bid is automatically updated over multiple time periods.

8. A method comprising:
identifying input specifying a preferred average cost target for a key word; and
automatically adjusting a bid for the keyword during a time window to achieve the preferred average cost target, using a linear combination of the bid and a previous bid for a previous time window, determined by a linear projection through an origin point on a plot of cost as a function of bid.

9. The method of claim 8, wherein the preferred average cost target is from a group of average cost targets including: a historical average cost-per-click (CPC), average cost-per-action (CPA), average return on investment (ROI) and average cost per thousand impressions (CPM).

10. The method of claim 9, wherein the historical average CPC is set equal to a maximum CPC.

11. The method of claim 8, wherein the preferred average cost target is multiplied by a factor.

12. A method comprising:
identifying input specifying a preferred average cost target for a keyword; and
automatically adjusting a bid for the keyword by setting the bid equal to a convex combination of weighted past linear projections on a plot of cost as a function of bid.

13. The method of claim 12, wherein weights applied to the past linear projections decrease geometrically as a function of time.

14. A system comprising:
a processor; and
a computer-readable medium coupled to the processor and including instructions, which, when executed by the processor, causes the processor to perform operations, comprising:
identifying input specifying a preferred average cost target for a keyword; and
automatically updating a bid for the keyword using historical performance data for the keyword to achieve the preferred average cost target.

15. The system of claim 14, where automatically updating a bid further comprises:
calculating a linear projection using historical performance data for a previous time period; and
setting the bid equal to a linear combination of the bid and a previous bid calculated from the linear projection.

16. The system of claim 15, wherein the linear projection includes an origin point.

17. The system of claim 14, wherein the preferred average cost target is from a group of average cost targets including: a historical average cost-per-click (CPC), average cost-per-action (CPA), average return on investment (ROI) and average cost per thousand impressions (CPM).

18. The system of claim 17, wherein the historical average CPC is set equal to a maximum CPC.

19. The system of claim 14, wherein the preferred average cost target is multiplied by a factor.

20. The system of claim 14, wherein the bid is automatically updated over multiple time periods.

21. A computer-readable medium having stored thereon instructions, which, when executed by a processor, causes the processor to perform operations comprising:
identifying input specifying a preferred average cost target for a keyword; and
automatically updating a bid for the keyword using historical performance data for the keyword to achieve the preferred average cost target.

22. A computer-readable medium having stored thereon instructions, which, when executed by a processor, causes the processor to perform operations comprising:
identifying input specifying a preferred average cost target for a key word; and
automatically adjusting a bid for the keyword during a time window to achieve the preferred average cost target, using a linear combination of the bid and a previous bid for a previous time window, determined by a linear projection through an origin point on a plot of cost as a function of bid.

23. A computer-readable medium having stored thereon instructions, which, when executed by a processor, causes the processor to perform operations comprising:
identifying input specifying a preferred average cost target for a keyword; and
automatically adjusting a bid for the keyword by setting the bid equal to a convex combination of weighted past linear projections on a plot of cost as a function of bid.

24. A system comprising:
means for identifying input specifying a preferred average cost target for a keyword; and
means for automatically updating a bid for the keyword using historical performance data for the keyword to achieve the preferred average cost target.
